(19) United States
(12) Patent Application Publication
(10) Pub. No.: US 2026/0266663 A1
(43) Pub. Date: Sep. 10, 2026

(54) SCANNING MOTHERBOARD TEMPERATURE WITHIN A CLOSED SERVER CHASSIS

(71) Applicant: Lenovo Global Technology (United States) Inc., Morrisville, NC (US)

(72) Inventors: Shreekanth Murthy Muthigi, Karnataka (IN); Chitransh Chandrakant Kulshreshtha, Kanpur (IN)

(21) Appl. No.: 19/072,939

(22) Filed: Mar. 6, 2025

(51) Int. Cl. G01J 5/10; G01J 5/00

(52) U.S. Cl. CPC G01J 5/10; G01J 2005/0077; G01J 2005/106

(57) ABSTRACT

An apparatus for scanning component temperatures in a server includes a temperature sensor array (“TSA”) that includes a grid of infrared (“IR”) sensors located within the TSA. The TSA is coupled to a structure facing electronic components of a server. The apparatus includes integrated electronics connected to the TSA where the integrated electronics are configured to provide a thermal image of an area below the TSA. The apparatus includes a motherboard of the server that includes a processor. The motherboard is coupled to the integrated electronics. The apparatus includes non-transitory computer readable storage media storing code. The code is executable by the processor to perform operations that include reading the thermal image and reporting the thermal image.

### FIELD

The subject matter disclosed herein relates to temperature monitoring and more particularly relates to temperature monitoring of a motherboard in a server with a closed server chassis.

### BACKGROUND

There are more than a few methods to monitor temperatures of the different parts of a server in an open chassis state, but few to none that can do the same in a closed server while in a functioning state. An issue at present is the inability to monitor temperature changes on the motherboard in a closed chassis operating state. Being able to monitor large scale temperature changes in this working state would enable the user to receive real time feedback to further investigate thermal anomalies in the server. In addition to general monitoring of the motherboard, the ability to observe and narrow down temperature changes in discrete components would be useful and would allow for quicker, preventative component replacement or repair before any malfunctioning components cause significant damage or loss in performance.

### BRIEF SUMMARY

An apparatus for scanning component temperatures in a server includes a temperature sensor array (“TSA”) that includes a grid of infrared (“IR”) sensors located within the TSA. The TSA is coupled to a structure facing electronic components of a server. The apparatus includes integrated electronics connected to the TSA where the integrated electronics are configured to provide a thermal image of an area below the TSA. The apparatus includes a motherboard of the server that includes a processor. The motherboard is coupled to the integrated electronics. The apparatus includes non-transitory computer readable storage media storing code. The code is executable by the processor to perform operations that include reading the thermal image and reporting the thermal image.

A system for scanning component temperatures in a server includes a server with a baseboard management controller (“BMC”) connected to a remote management server over a management network and a TSA that includes a grid of IR sensors located within the TSA. The TSA is coupled to a structure facing electronic components of the server. The server includes integrated electronics connected to the TSA. The integrated electronics are configured to provide a thermal image of an area below the TSA. The server includes a motherboard of the server with a processor. The motherboard is coupled to the integrated electronics. The server includes non-transitory computer readable storage media storing code. The code being executable by the processor to perform operations that include reading the thermal image, determining temperatures of the components of the server, and reporting the temperatures of the components of the server.

An apparatus for scanning component temperatures in a server includes a TSA that includes a grid of IR sensors located within the TSA. The TSA is coupled to a structure facing electronic components of a server. The apparatus includes integrated electronics connected to the TSA. The integrated electronics are configured to provide a thermal image of an area below the TSA. The apparatus includes a motherboard of the server that includes a processor. The motherboard is coupled to the integrated electronics. The apparatus includes non-transitory computer readable storage media storing code. The code is executable by the processor to perform operations that include mapping components under the TSA with locations on a thermal image of the TSA, reading, using the TSA and during a training phase, thermal images during various conditions that include startup conditions, transient conditions, and/or various operating conditions, correlating, using machine learning during the training phase, temperatures of the components of the thermal images with the various conditions to establish baseline temperatures of the components at the various conditions, and creating, during the training phase and using machine learning, a temperature envelope for one or more components of the server based on the temperature correlations. The operations also include reading, during an operational phase, a thermal image during a particular condition, comparing, during the operational phase, a temperature of a component from the thermal image with a temperature envelope for the component corresponding to the particular condition, and sending an alert in response to a temperature of the component exceeding the temperature envelope by a specified amount. The operations include updating the temperature envelopes of the components during the operational phase.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a perspective view of a server with a chassis cover that includes a TSA, according to various embodiments;

FIG. 2 is a schematic block diagram illustrating a first TSA with a first spacing of IR sensors and a second TSA with a second spacing of IR sensors, each with an integrated electronics circuit, according to various embodiments;

FIG. 3 is a schematic block diagram illustrating a portion of a first TSA with a first spacing of IR sensors and a portion of a second TSA with a second spacing of IR sensors where the first and second TSAs share a single integrated electronics circuit, according to various embodiments;

FIG. 4 is a schematic block diagram illustrating a section view of a server and a chassis cover depicting a first TSA on the chassis cover, a second TSA on the underside of a duct, and a third TSA on a bottom of a chassis of the server, according to various embodiments;

FIG. 5 is a schematic block diagram illustrating a bottom TSA sheet connected to top TSA sheet connected to a TSA sheet under a duct and an integrated electronics circuit, according to various embodiments;

FIG. 6 is a schematic block diagram illustrating several TSA flex printed circuit boards connected to an interconnect board which is connected to a motherboard, according to various embodiments;

FIG. 7 is a schematic block diagram illustrating a thermal apparatus for processing data from a TSA, according to various embodiments;

FIG. 8 is a schematic block diagram illustrating another thermal apparatus for processing data from TSAs, according to various embodiments;

FIG. 9 is a thermal image from a TSA, according to various embodiments;

FIG. 10 is a schematic flow chart diagram illustrating a method for processing data from a TSA, according to various embodiments; and

FIG. 11 is a schematic flow chart diagram illustrating another method for processing data from a TSA using machine learning, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the "C" programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

An apparatus for scanning component temperatures in a server includes a temperature sensor array (“TSA”) that includes a grid of infrared (“IR”) sensors located within the TSA. The TSA is coupled to a structure facing electronic components of a server. The apparatus includes integrated electronics connected to the TSA where the integrated electronics are configured to provide a thermal image of an area below the TSA. The apparatus includes a motherboard of the server that includes a processor. The motherboard is coupled to the integrated electronics. The apparatus includes non-transitory computer readable storage media storing code. The code is executable by the processor to perform operations that include reading the thermal image and reporting the thermal image.

In some embodiments, the TSA is a first TSA with first IR sensors that are spaced apart from each other at a first spacing and the apparatus includes a second TSA with second IR sensors that are spaced apart from each other at a second spacing. The first spacing is different than the second spacing. In other embodiments, the second spacing of the second TSA is smaller than the first spacing of the first TSA. In other embodiments, the second TSA is placed to over components that are closer to the second TSA than components under the first TSA and/or is placed over components of the server where more precision is desired than components over which the first TSA is placed. In some embodiments, the second TSA is connected to the integrated electronics, and the integrated electronics is configured to provide a thermal image of an area below the second TSA. In other embodiments, the integrated electronics is a first integrated electronics and the second TSA is connected to a second integrated electronics different from the first integrated electronics. The second integrated electronics is configured to provide a thermal image of an area below the second TSA and the motherboard is coupled to the second integrated electronics.

In some embodiments, the IR sensors of the TSA are equally spaced in a square grid pattern, spaced in a circular pattern, or spaced in a random pattern. In other embodiments, the structure facing the components of the server includes a chassis cover, an underside of an air duct, and a bottom of a chassis of the server. The TSA on the bottom of the chassis is located to face an underside of the motherboard. In other embodiments, the apparatus the non-transitory computer readable storage media stores further code executable by the processor to perform operations that include corelating components of the server with locations on the thermal image where reading the thermal image includes reading temperatures on the thermal image corelated with components of the server. In other embodiments, the processor is in a baseboard management controller (“BMC”) connected to a management network.

In some embodiments, the non-transitory computer readable storage media stores further code executable by the processor to perform further operations that include determining temperatures of components of the server, comparing a determined temperature of a component of the server with a temperature limit, and reporting a temperature alert in response to the determined temperature being above the temperature limit. In other embodiments, wherein the non-transitory computer readable storage media stores further code executable by the processor to perform further operations that include mapping components under the TSA with locations on a thermal image of the TSA, reading, using the TSA, thermal images during various conditions that include startup conditions, transient conditions, and/or various operating conditions, correlating temperatures of the components of the thermal images with the various conditions to establish baseline temperatures of the components at the various conditions, and creating a temperature envelope for one or more components of the server based on the temperature correlations.

In other embodiments, correlating the temperatures with the various conditions uses machine learning during a training phase and reading the thermal image includes reading thermal images during various additional conditions, and the operations include comparing, during an operational phase, temperatures of a component from the thermal images with the temperature envelope for the component, and sending an alert in response to a temperature of the component exceeding the temperature envelope by a specified amount. In other embodiments, the operations include updating the temperature envelopes of the components during the operational phase.

A system for scanning component temperatures in a server includes a server with a BMC connected to a remote management server over a management network and a TSA that includes a grid of IR sensors located within the TSA. The TSA is coupled to a structure facing electronic components of the server. The server includes integrated electronics connected to the TSA. The integrated electronics are configured to provide a thermal image of an area below the TSA. The server includes a motherboard of the server with a processor. The motherboard is coupled to the integrated electronics. The server includes non-transitory computer readable storage media storing code. The code being executable by the processor to perform operations that include reading the thermal image, determining temperatures of the components of the server, and reporting the temperatures of the components of the server.

In some embodiments, the TSA is a first TSA with first IR sensors that are spaced apart from each other at a first spacing and the system includes a second TSA with second IR sensors that are spaced apart from each other at a second spacing. The first spacing is different than the second spacing. The integrated electronics is a first integrated electronics and the second TSA is connected to the first integrated electronics or a second integrated electronics. The first or second integrated electronics are coupled to the second TSA configured to provide a thermal image of an area below the second TSA. The first or second integrated electronics connected to the second TSA are connected to the motherboard. In other embodiments, the structure facing the components of the server includes a chassis cover, an underside of an air duct, and a bottom of a chassis of the server where the TSA on the bottom of the chassis is located to face an underside of the motherboard.

In some embodiments, the non-transitory computer readable storage media stores further code executable by the processor to perform operations that include corelating components of the server with locations on the thermal image. Reading the thermal image and determining temperatures of the electronic components of the server includes reading a temperature on the thermal image corelated with each component of the server. In other embodiments, the non-transitory computer readable storage media stores further code executable by the processor to perform operations that include mapping components under the TSA with locations on a thermal image of the TSA, reading, using the TSA, thermal images during various conditions that include startup conditions, transient conditions, and/or various operating conditions, correlating temperatures of the components of the thermal images with the various conditions to establish baseline temperatures of the components at the various conditions, and creating a temperature envelope for one or more components of the server based on the temperature correlations.

In other embodiments, correlating the temperatures with the various conditions uses machine learning during a training phase and reading the thermal image includes reading thermal images during various conditions, and the operations include comparing, during an operational phase, temperatures of a component from the thermal images with the temperature envelope for the component and sending an alert in response to a temperature of the component exceeding the temperature envelope by a specified amount. In some embodiments, the operations include updating the temperature envelopes of the components during the operational phase.

An apparatus for scanning component temperatures in a server includes a TSA that includes a grid of IR sensors located within the TSA. The TSA is coupled to a structure facing electronic components of a server. The apparatus includes integrated electronics connected to the TSA where the integrated electronics are configured to provide a thermal image of an area below the TSA. The apparatus includes a motherboard of the server that includes a processor. The motherboard is coupled to the integrated electronics. The apparatus includes non-transitory computer readable storage media storing code. The code is executable by the processor to perform operations that include mapping components under the TSA with locations on a thermal image of the TSA, and reading, using the TSA and during a training phase, thermal images during various conditions that include startup conditions, transient conditions, and/or various operating conditions. The operations include correlating, using machine learning during the training phase, temperatures of the components of the thermal images with the various conditions to establish baseline temperatures of the components at the various conditions, and creating, during the training phase and using machine learning, a temperature envelope for one or more components of the server based on the temperature correlations. The operations also include reading, during an operational phase, a thermal image during a particular condition, comparing, during the operational phase, a temperature of a component from the thermal image with a temperature envelope for the component corresponding to the particular condition, and sending an alert in response to a temperature of the component exceeding the temperature envelope by a specified amount. The operations include updating the temperature envelopes of the components during the operational phase.

In some embodiments, the structure facing the components of the server include a chassis cover, an underside of an air duct, and a bottom of a chassis of the server. The TSA on the bottom of the chassis is located to face an underside of the motherboard.

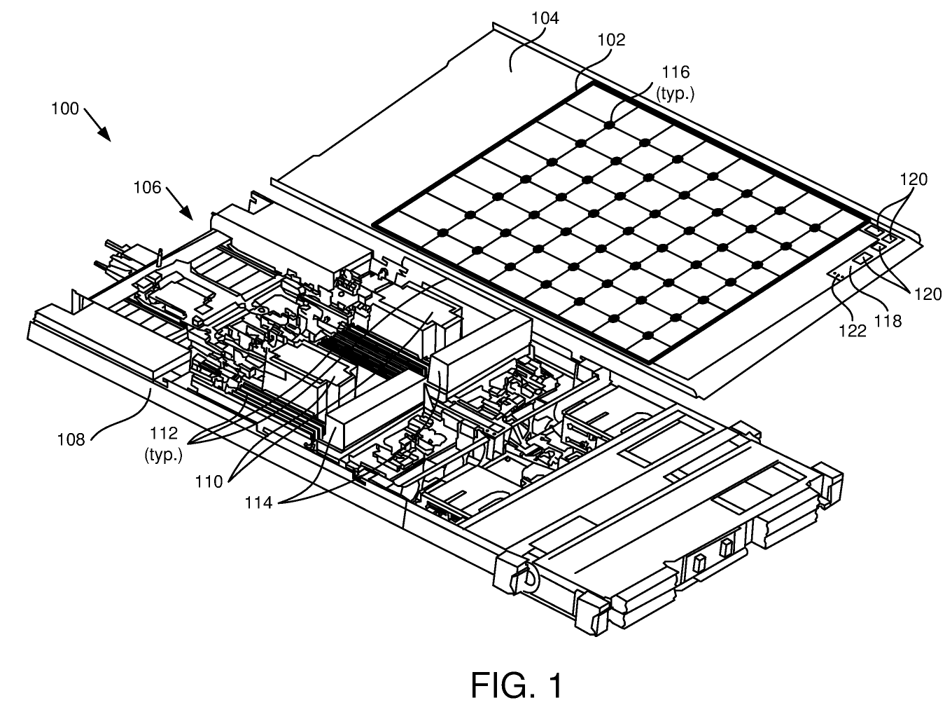

FIG. 1 is a schematic block diagram 100 illustrating a perspective view of a server 106 with a chassis cover 104 that includes a temperature sensor array (“TSA”) 102, according to various embodiments. The TSA is a grid of infrared (“IR”) sensors 116. In some embodiments, the TSA is on a printed circuit board (“PCB”). In some embodiments, the TSA is on a flexible PCB. The server 106 is in a chassis 108 and includes processors 110 each under a heat sink and memory cards 112, such as dual inline memory modules (“DIMMs”). The server 106 includes data storage devices 114, such as solid-state non-volatile memory. In some embodiments, the server 106 includes a baseboard management controller (“BMC”). The server 106 is populated with numerous hardware circuits, such as peripheral component interconnect express (“PCIe”) cards, a network interface card (“NIC”), integrated circuits, capacitors, inductors, resistors, and the like. The TSA 102 is positioned over the various components of the server 106.

The IR sensors 116, in some embodiments, are spaced on a grid. In some embodiments, the grid is square. In some embodiments, the IR sensors 116 are spaced 0.5 inches apart on a square grid. In other embodiments, the IR sensors 116 are spaced apart a different distance. In some embodiments, the IR sensors 116 are placed closer together for areas where the TSA 102 is closer to components. In some embodiments, the IR sensors 116 are placed closer together for areas where additional focus is desired. In some embodiments, the IR sensors 116 are spaced in a range of 0.125 inches apart to 1.5 inches apart. In some embodiments, the IR sensors 116 are not spaced in a square grid, but instead are spaced in some other pattern, such as in a rectangular grid, in a hexagonal grid, or the like.

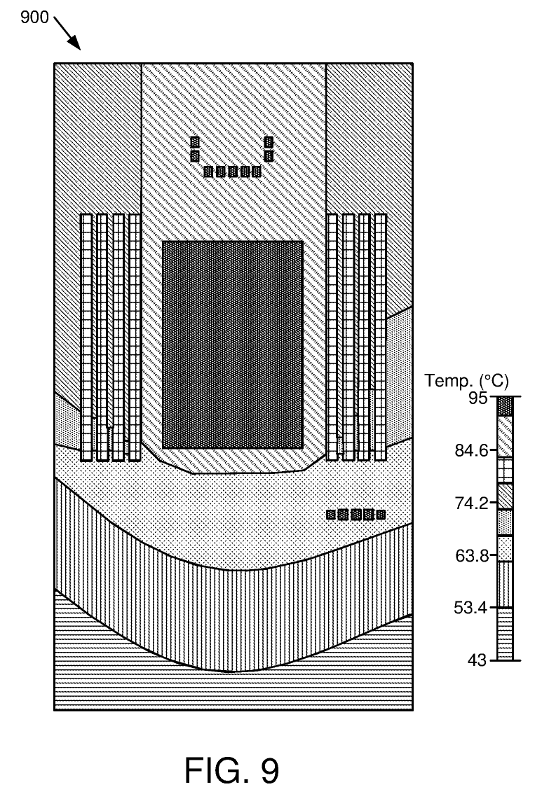

In some embodiments, the TSA 102 includes a PCB 118, such as a flexible PCB, with integrated electronics 120 and a connector 122. In other embodiments, the TSA 102 includes a connector 122 on a PCB 118 or on the TSA 102 and signals from the IR sensors 116 of the TSA 102 are processed elsewhere. In embodiments where the TSA 102 includes integrated electronics 120 on a PCB 118, signals from the IR sensors 116 are processed by the integrated electronics 120. In some embodiments, the integrated electronics 120 produce a thermal image of the components of the server 106, such as the thermal image 900 of FIG. 9. In other embodiments, the integrated electronics 120 are capable of producing additional information, such as determining when a temperature limit of a component has exceeded a thermal threshold.

In some embodiments, the IR sensors 116 each produce a small thermal image and the thermal images are combined into a large thermal image covering the area under the TSA 102 by the integrated electronics. Typically, the thermal image is a color image where various covers represent different temperatures. In other embodiments, the IR sensors 116 produce different shades of grey that represent different colors. In other embodiments, the IR sensors 116 transmit different temperatures of an image in a different format.

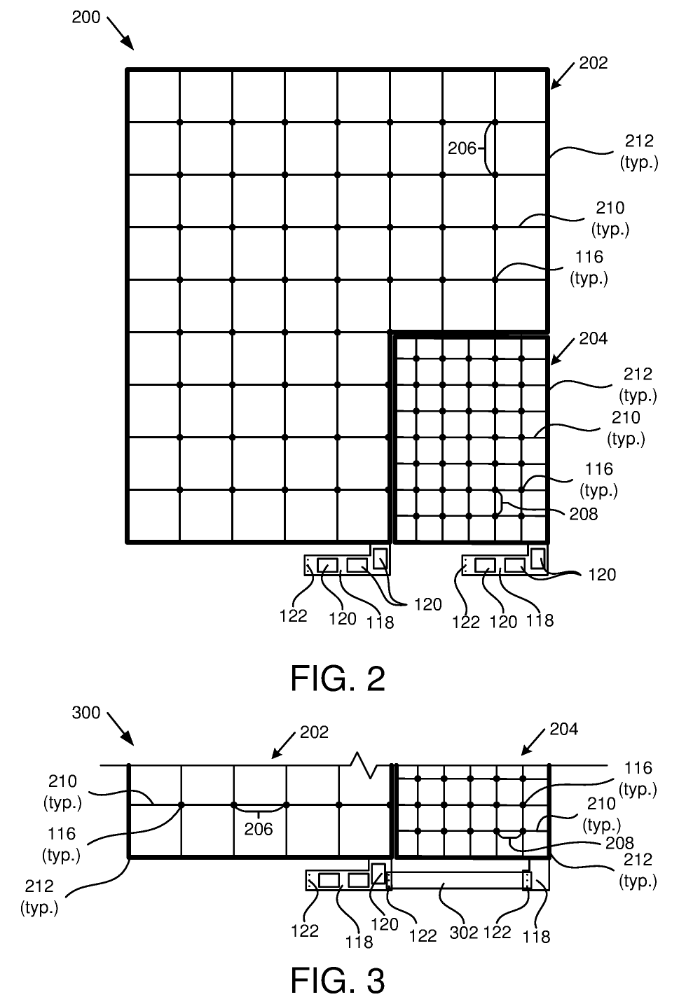

FIG. 2 is a schematic block diagram 200 illustrating a first TSA 202 with a first spacing 206 of IR sensors 116 and a second TSA 204 with a second spacing 208 of IR sensors 116, each with an integrated electronics circuit 120, according to various embodiments. In some embodiments, the first TSA 202 is similar to the TSA 102 of FIG. 1. In some embodiments, the first spacing 206 is 0.5 inches and the second spacing 208 is 0.25 inches. In other embodiments, the first spacing 206 and the second spacing 208 are different. While the second TSA 204 is depicted in the bottom right corner of the first TSA 202, in other embodiments the second TSA 204 is in a different location. The first TSA 202 and the second TSA 204 are each depicted with a grid of wires 210. In other embodiments, the IR sensors 116 are as depicted while the wiring 210 only runs to each IR sensor 116 a single time. The exterior of the first TSA 202 and the second TSA 204 include a heavy line around the perimeter, which is intended to depict heavier wiring 212 running to the integrated electronics 120. Other embodiments include wiring 212 on the ends only as needed.

The diagram 200 of FIG. 2 depicts the first TSA 202 and the second TSA 204 each with a separate integrated electronics 120 and associated PCB 118 and connector 122. FIG. 3 is a schematic block diagram 300 illustrating a portion of a first TSA 202 with a first spacing 206 of IR sensors 116 and a portion of a second TSA 204 with a second spacing 208 of IR sensors 116 where the first TSA 202 and the second TSA 204 share a single integrated electronics circuit 120, according to various embodiments. Both the first TSA 202 and the second TSA 204 each have wiring 210 and perimeter wiring 212 as in FIG. 2.

In the depicted embodiment, the second TSA 204 includes a PCB 118 and connector 122, but does not include integrated electronics 120. A ribbon connector 302 connects the PCB 118 of the second TSA 204 with the PCB 118 of the first TSA 202 via connectors 122. The integrated electronics circuit 120 of the first TSA 202 processes signals from IR sensors 116 from the first TSA 202 and the second TSA 204. In some embodiments, the integrated electronics 120 of FIG. 2 and/or FIG. 3 receive a signal from each IR sensor 116 and integrates the thermal image of each IR sensor 116 into a unified thermal image the size of the first TSA 202 and the second TSA 204. In some embodiments, the integrated electronics 120 creates a thermal image for the area under the first TSA 202 and a second thermal image for the area under the second TSA 204. In other embodiments, the integrated electronics 120 creates a single thermal image for the area under the first and second TSAs 202, 204.

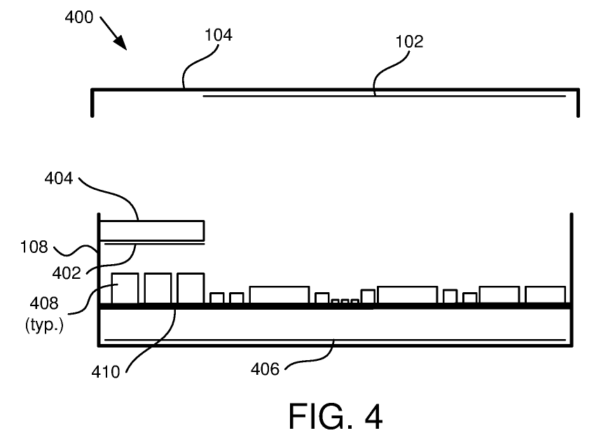

FIG. 4 is a schematic block diagram 400 illustrating a section view of a server 106 and a chassis cover 104 depicting a first TSA 102 on the chassis cover 104, a second TSA 402 on the underside of a duct 404, and a third TSA 406 on a bottom of a chassis 108 of the server 106, according to various embodiments. In other embodiments, a TSA is positioned elsewhere in any location where components are to be monitored and are covered by a structure, a duct, a component, or other element of the server 106. The diagram 400 includes a motherboard 410 with various components 408. The first TSA 102 and the second TSA 402 are positioned to view the components 408 of the server 106. The second TSA 402 is positioned closer to the components 408 than the first TSA 102 and, in some embodiments, has a grid with IR sensors 116 closer together than the first TSA 102. The third TSA 406 is positioned so that IR sensors 116 of the third TSA 406 view the bottom side of the motherboard 410. Note that the chassis cover 104 is depicted up and off of the chassis 108 of the server 106, but would be fastened down during operation.

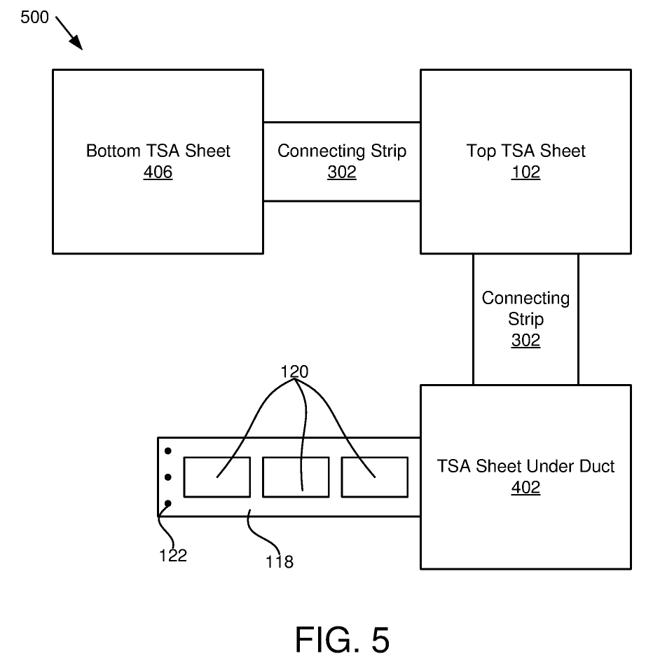

FIG. 5 is a schematic block diagram 500 illustrating a bottom TSA sheet (third TSA 406) connected to top TSA sheet (first TSA 102) connected to a TSA sheet (second TSA 402) under a duct 404 and an integrated electronics circuit 120, according to various embodiments. The bottom TSA sheet 406 is connected to the top TSA sheet 102 via a ribbon connector strip 302 and the top TSA sheet 102 is connected to the TSA sheet 402 under the duct 404 via a second ribbon connector strip 302. The TSA sheet 402 under the duct 404 is connected to a PCB 118 with an integrated electronics circuit 120 and a connector 122. While the PCB 118 is depicted connected to the TSA sheet 402 under the duct 404, in other embodiments the PCB 118 is connected to the top TSA sheet 102 or the bottom TSA sheet 406 and the ribbon connector strips 302 are connected differently.

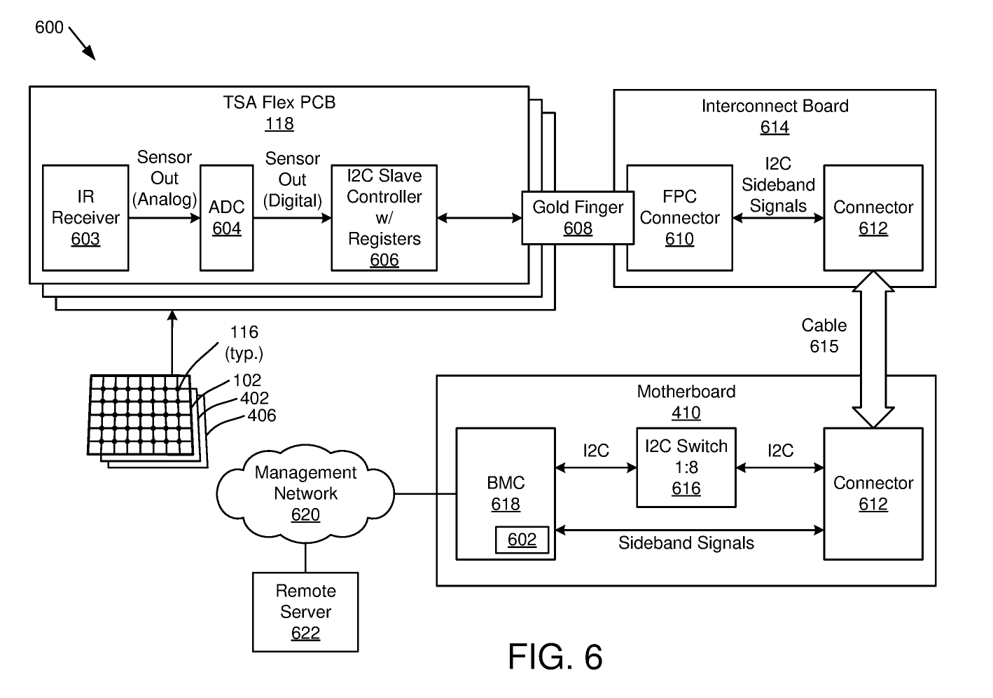

FIG. 6 is a schematic block diagram 600 illustrating several TSA flex printed circuit boards 118 connected to an interconnect board 614 which is connected to a motherboard 410, according to various embodiments. Each TSA Flex PCB 118 includes an IR receiver 603 connected to the various IR sensors 116 of the TSAs 102, 402, 406 where the signals received from the IR sensors 116 are analog. The signals from the IR sensors 116 are fed into an analog-to-digital converter (“ADC”) 604. Once the ADC 604 converts the signals to digital, the sensor output signals in digital form are sent, in some embodiments, to an inter-integrated circuit (“I2C”) slave controller 606 with registers. In some embodiments, the I2C slave controller 606 creates a thermal image from the digital signals from the IR sensors 116 and stores the thermal image in the registers. In other embodiments, the I2C slave controller 606 transmits the thermal image of the components 408 of the motherboard 410 of the server 106. In other embodiments, the I2C slave controller 606 is replaced with another processor or controller using a different signal format than I2C. In various embodiments, the integrated electronics circuit 120 includes the IR receiver 603, the ADC 604, and the I2C slave controller 606 with registers.

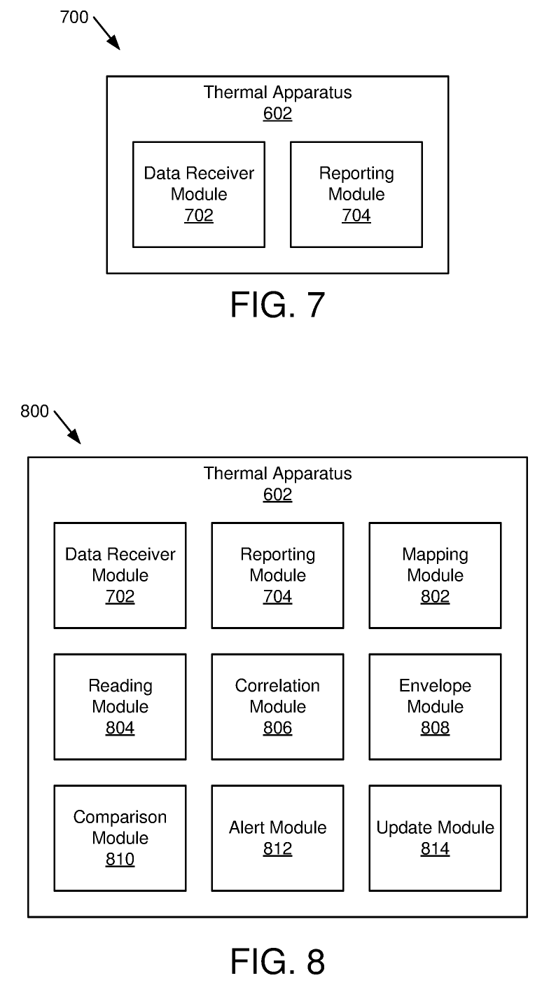

The output of the I2C slave controller 606 is transmitted to a flexible printed circuit (“FPC”) connector 610 of an interconnect board 614 that transmits I2C signals and sideband signals to a connector 612, which is connected via cable 615 to a connector 612 on the motherboard 410. In some embodiments, the interconnect board 614 is in the server 106. In some embodiments, the interconnect board 614 is on the motherboard 410. In other embodiments, the interconnect board 614 is mounted elsewhere within the server 106. The connector 612 is connected, in some embodiments, to an I2C switch 616, which is connected to a BMC 618 on the motherboard 410. The connector 612 on the motherboard 410 is also connected to the BMC 618 and transmits the sideband signals. The BMC 618 is then able to report the thermal images from the TSAs 102, 402, 406 and do other processing. In some embodiments, the BMC 618 includes a thermal apparatus 602 configured to analyze and process the thermal images from the TSAs 102, 402, 406, as explained further with regards to the apparatuses 700, 800 of FIGS. 7 and 8.

In some embodiments, the BMC 618 is connected to a remote server 622 over a management network 620. The remote server 622, in various embodiments, monitors the server 106 through the BMC 618, sends commands, such as fan speed settings, startup commands, software update commands, etc. In some embodiments, the remote server 622 delivers software updates and firmware updates to the BMC 618 for installation on the BMC 618 and the server 106. The management network 620 is typically separate from a computer network used by the server 106 to communicate with clients, to service workloads, etc. In some embodiments, the management network 620 uses the same computer network of the server 106, but is encrypted, protected, etc. In some embodiments, the management network includes a LAN, a WAN, a fiber network , or the like and may include a wireless connection.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

FIG. 7 is a schematic block diagram illustrating a thermal apparatus 700 for processing data from a TSA 102, 402, 406, according to various embodiments. The apparatus 700 includes a thermal apparatus 602 with a data receiver module 702 and a reporting module 704, which are described below. In some embodiments, the apparatus 700 is implemented with executable code stored on computer readable storage media. In other embodiments, all or a portion of the apparatus 700 is implemented using a programmable hardware device and/or hardware circuits.

The apparatus 700 includes a data receiver module 702 configured to read a thermal image, for example, sent from the integrated electronics circuit 120 to the BMC 618. In some embodiments, the data receiver module 702 receives the thermal image by way of I2C signals. In other embodiments, the data receiver module 702 receives the thermal image by way of signals in a different format.

The apparatus 700 includes a reporting module 704 configured to report the thermal image. The reporting module 704, in some embodiments, transmits the thermal image in the form of a file, such as a portable document format (“pdf”) file. In other embodiments, the reporting module 704 reports the thermal image in another format. In some embodiments, the reporting module 704 is configured to determine temperatures of the components 408 of the server 106 and to report the temperatures of the components 408 of the server 106. In some embodiments, the reporting module 704 has a mapping of the various electronic components 408 and uses the mapping to determine the temperature of the various components. In some embodiments, the reporting module 704 transmits the temperatures of the components.

FIG. 8 is a schematic block diagram illustrating another thermal apparatus 800 for processing data from TSAs 102, 402, 406, according to various embodiments. The apparatus 800 includes another thermal apparatus 602 with a data receiver module 702 and a reporting module 704, which are substantially similar to those described above in relation to the apparatus 700 of FIG. 7. In various embodiments, the apparatus 800 includes a mapping module 802, a reading module 804, a correlation module 806, an envelope module 808, a comparison module 810, an alert module 812, and/or an update module 814, which are described below. In some embodiments, the apparatus 800 is implemented with executable code stored on computer readable storage media. In other embodiments, all or a portion of the apparatus 800 is implemented using a programmable hardware device and/or hardware circuits.

In some embodiments, the apparatus 800 includes a mapping module 802 configured to map components 408 under a TSA (e.g., 102) with locations on a thermal image of the TSA 102. The components 408 are in the server 106. In some embodiments, some or all of the components 408 are connected to the motherboard 410 of the server 106. In other embodiments, some of the components 408 are mounted to the chassis 108 or other location of the server 106 without being mounted to the motherboard 410.

In some embodiments, the mapping module 802 is provided with a map of components 408 of the server 106. In other embodiments, the mapping module 802 receives input from a user to map locations of the components 408 to a grid, an image of the components 408, etc. In response to the mapping module 802 having locations of the components 408, the mapping module 802 maps the components 408 under a TSA (e.g., 102) to locations on the thermal image produced by the TSA 102.

In some embodiments, the apparatus 800 includes a reading module 804 configured to read, using the TSA (e.g., 102), thermal images during various conditions including startup conditions, transient conditions, and/or various operating conditions. For a particular thermal image of a TSA (e.g., 102) the reading module 804 determines a temperature for each component 408 of the server 106 based on the mapping of components by the mapping module 802. The reading module 804, in some embodiments, stores conditions at the time the thermal image was derived.

In various embodiments, the apparatus 800 includes a correlation module 806 configured to correlate temperatures of the components 408 of the thermal images with the various conditions to establish baseline temperatures of the components 408 at the various conditions. Thus, for a particular component 408, the correlation module 806 stores a separate temperature for each condition associated with various thermal images. In some embodiments, the reading module 804 and the correlation module 806 operate during a 408 during a training phase. In other embodiments, the reading module 804 and/or the correlation module 806 use machine learning to correlate the temperatures of the components 408 to the various operating conditions.

In some embodiments, the apparatus 800 includes an envelope module 808 configured to create a temperature envelope for one or more components 408 of the server 106 based on the temperature correlations of the correlation module 806. In some embodiments, the envelope module 808, along with the reading module 804 and the correlation module 806, use machine learning to create the temperature envelope. The temperature envelope, in some embodiments, covers various operating conditions, such as different loading conditions from no load to full load of the server 106, startup conditions, transient conditions, etc. As various conditions are encountered, the machine learning uses averaging techniques, extrapolation techniques, etc. to combine temperatures from like operating conditions. In some examples, the machine learning extrapolates between points at various conditions, to create a continuous line for a component between operating conditions from a low to a high.

In some embodiments, the thermal apparatus 602 is on several servers 106 that are in communication with a remote server 622. The remote server 622 gathers information from the BMCs 618 and an envelope module 808 on the remote server 622 combines the information into a temperature envelope to be used by various servers 106 during an operation mode.

In some embodiments, the apparatus 800 includes a comparison module 810 configured to compare, during an operational phase, temperatures of a component 408 from the thermal images with the temperature envelope for the component 408. In some embodiments, the comparison module 810 determines an operating condition of the time of the thermal image and selects a matching temperature envelope for the component 408 before comparing a temperature of the component 408 from the temperature envelope.

The apparatus 800, in some embodiments, includes an alert module 812 configured to send an alert in response to a temperature of the component 408 exceeding the temperature envelope by a specified amount. In some embodiments, the temperature of the component 408 is for a particular operating condition and the temperature envelope is for the component 408 at the particular operating condition. In other embodiments, the specified amount is a particular amount of degrees. For example, if the temperature of the temperature envelope the component 408 for the particular condition of the thermal image is 30 degrees Celsius (“C”) and the specified amount is 5 degrees C, the alert module 812 will send an alert for temperatures of the component 408 at the particular operating condition exceeding 35 degrees C. In some embodiments, the specified amount is an amount above the temperature envelope where the component temperature would be abnormal, of a concern, etc. In some embodiments, the temperature envelope is derived using temperatures of concern (i.e., a temperature limit) for the various operating conditions and the specified amount is zero degrees.

In some embodiments, the alert module 812 transmits various alerts for different conditions, temperatures above the temperature envelopes, etc. In some examples, the alert module 812 sends a caution alert in response to the component temperature being 5 degrees above the corresponding temperature envelope. In other examples, the alert module 812 sends a danger of immanent failure alert for component temperatures being 15 degrees above the corresponding temperature envelope. One of skill in the art will recognize other alerts and amounts above the corresponding temperature envelope to send the alerts.

In some embodiments, the alert module 812 transmits the alert via an email, a text message, etc. to a system administrator. In other embodiments, the alert module 812 transmits the alert to the BMC 618 and the BMC 618 determines an appropriate action for the alert. The BMC actions may include transmitting the alert to a system administrator, transmitting the alert to the remote server 622, transmitting the alert to the server 106, and the like.

The apparatus 800, in some embodiments, includes an update module 814 configured to update the temperature envelopes of the components 408 during the operational phase. In some embodiments, the update module 814 uses the machine learning to update the various temperature envelopes. Updating the temperature envelopes provides a way for the machine learning to continue to refine the temperature envelopes during the operational phase.

FIG. 9 is a thermal image from a TSA (e.g., 102, 402, 408), according to various embodiments. In some embodiments, the thermal image is from a first TSA 102 on the chassis cover 104 that covers a large portion of the components 408 of the server 106, such as those mounted to the motherboard 410. In other embodiments, the thermal image is from a compilation of two or more TSAs, such as the first TSA 102 mounted to the chassis cover 104 and another TSA 402 mounted to the bottom side of a duct 404.

The thermal image depicts different temperatures as areas with different hatching. The highest temperature zone in the middle is for a processor. The processor has DIMMs on either side that are a lower temperature, and are represented by rectangles with horizontal hatching. An actual thermal image includes color where the various colors represent different temperatures.

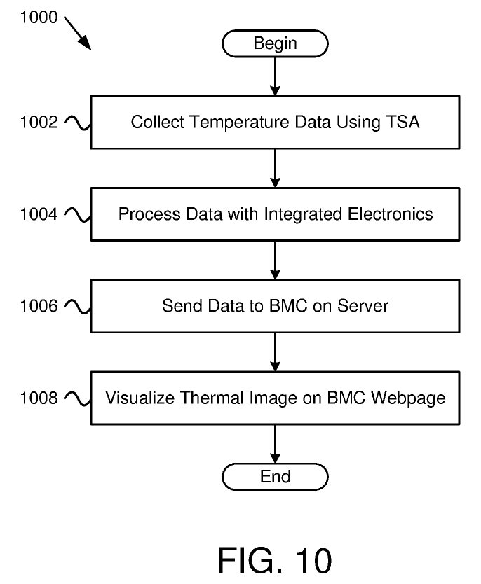

FIG. 10 is a schematic flow chart diagram illustrating a method 1000 for processing data from a TSA (e.g., 102, 402, 408), according to various embodiments. The method 1000 begins and collects 1002 temperature data using a TSA (e.g., 102) of a server 106. In some examples, the TSA 102 includes IR sensors 116 in a grid where temperature information from the IR sensors 116 are combined into a thermal image of the area under the TSA 102. In some embodiments, the TSA is located under a chassis cover 104, under an air duct 404, on the bottom of a chassis 108 of the server 106, etc. The method 1000 processes 1004 data from the IR sensors 116 using integrated electronics 120, which produces the thermal image. In some embodiments, the integrated electronics 120 combines the thermal images of the IR sensors 116 into a single thermal image of the area under the TSAs (e.g., 102, 402).

The method 1000 sends 1006 temperature data of various components 408 of the server to the BMC 618 on the motherboard 410 of the server. The method 1000 visualizes 1008 a thermal image on a webpage of the BMC 618, and the method 1000 ends. In various embodiments, all or a portion of the method 1000 is implemented using the data receiver module 702 and/or the reporting module 704.

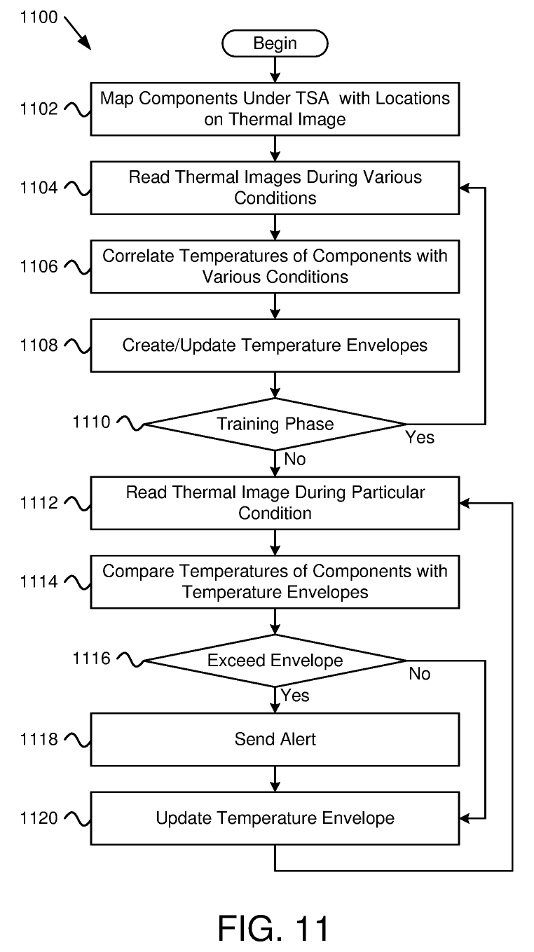

FIG. 11 is a schematic flow chart diagram illustrating another method 1100 for processing data from a TSA (e.g., 102, 402, 408) using machine learning, according to various embodiments. The method 1100 begins and maps 1102 components under a TSA (e.g., 102) on a thermal image of the TSA 102. In some embodiments, the method 1100 uses the integrated electronics 120 to create a thermal image under the TSA 102 and the mapping module 802 to map the components under the TSA 102 to locations on the thermal image.

The method 1100 reads 1104, using the TSA 102, thermal images during various conditions that include startup conditions, transient conditions, and/or various operating conditions and correlates 1106, using machine learning during training phase, temperatures of the components of the thermal images with the various conditions to establish baseline temperatures of the components at the various conditions. The method 1100 creates 1108, during the training phase, a temperature envelope for one or more components of the server 106 based on the temperature correlations and determines 1110 if the training phase is complete. If the method 1100 determines 1110 that the training phase is not complete, the method 1100 returns and reads 1104 thermal images during various conditions.

If the method 1100 determines 1110 that the training phase is over, the method 1100 reads 1112 a thermal image during a particular condition and compares 1114, during the operational phase, a temperature of a component from the thermal image with a temperature envelope for the component corresponding to the particular condition. The method 1100 determines 1116 if the temperature of the component exceeds the temperature envelope by a specified amount. If the method 1100 determines 1116 that the temperature of the component exceeds the temperature envelope by the specified amount, the method 1100 sends 1118 and alert, updates 1120 the temperature envelope, and returns and reads 1112 a thermal image during a particular condition. If the method 1100 determines 1116 that the temperature of the component does not exceed the temperature envelope by the specified amount, the method 1100 updates 1120 the temperature envelope and returns and reads 1112 a thermal image during a particular condition. In various embodiments, all or a portion of the method 1100 is implemented using the data receiver module 702, the reporting module 704, the mapping module 802, the reading module 804, the correlation module 806, the envelope module 808, the comparison module 810, the alert module 812, and/or the update module 814.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a temperature sensor array (“TSA”) comprising a grid of infrared (“IR”) sensors located within the TSA, the TSA coupled to a structure facing electronic components of a server;
integrated electronics connected to the TSA, the integrated electronics configured to provide a thermal image of an area below the TSA;
a motherboard of the server comprising a processor, the motherboard coupled to the integrated electronics;
non-transitory computer readable storage media storing code, the code being executable by the processor to perform operations comprising:
reading the thermal image; and
reporting the thermal image.

2. The apparatus of claim 1, wherein the TSA is a first TSA comprising first IR sensors that are spaced apart from each other at a first spacing, the apparatus further comprising a second TSA comprising second IR sensors that are spaced apart from each other at a second spacing, the first spacing different than the second spacing.

3. The apparatus of claim 2, wherein the second spacing of the second TSA is smaller than the first spacing of the first TSA.

4. The apparatus of claim 3, wherein the second TSA:
is placed to over components that are closer to the second TSA than components under the first TSA; and/or
is placed over components of the server where more precision is desired than components over which the first TSA is placed.

5. The apparatus of claim 2, wherein the second TSA is connected to the integrated electronics, the integrated electronics configured to provide a thermal image of an area below the second TSA.

6. The apparatus of claim 2, wherein the integrated electronics is a first integrated electronics, and the second TSA is connected to a second integrated electronics different from the first integrated electronics, the second integrated electronics configured to provide a thermal image of an area below the second TSA, the motherboard coupled to the second integrated electronics.

7. The apparatus of claim 1, wherein the IR sensors of the TSA are one of equally spaced in a square grid pattern, spaced in a circular pattern, and placed in a random pattern.

8. The apparatus of claim 1, wherein the structure facing the components of the server comprises a chassis cover, an underside of an air duct, and a bottom of a chassis of the server, the TSA on the bottom of the chassis is located to face an underside of the motherboard.

9. The apparatus of claim 1, wherein the non-transitory computer readable storage media stores further code executable by the processor to perform further operations comprising corelating components of the server with locations on the thermal image, wherein reading the thermal image comprises reading temperatures on the thermal image corelated with components of the server.

10. The apparatus of claim 1, wherein the processor is in a baseboard management controller (“BMC”) connected to a management network.

11. The apparatus of claim 1, wherein the non-transitory computer readable storage media stores further code executable by the processor to perform further operations comprising:
determining temperatures of components of the server;
comparing a determined temperature of a component of the server with a temperature limit; and
reporting a temperature alert in response to the determined temperature being above the temperature limit.

12. The apparatus of claim 1, wherein the non-transitory computer readable storage media stores further code executable by the processor to perform further operations comprising:
mapping components under the TSA with locations on a thermal image of the TSA;
reading, using the TSA, thermal images during various conditions comprising startup conditions, transient conditions, and/or various operating conditions;
correlating temperatures of the components of the thermal images with the various conditions to establish baseline temperatures of the components at the various conditions; and
creating a temperature envelope for one or more components of the server based on the temperature correlations.

13. The apparatus of claim 12, wherein correlating the temperatures with the various conditions uses machine learning during a training phase and wherein reading the thermal image comprises reading thermal images during various additional conditions, and further comprising:
comparing, during an operational phase, temperatures of a component from the thermal images with the temperature envelope for the component; and
sending an alert in response to a temperature of the component exceeding the temperature envelope by a specified amount.

14. The apparatus of claim 13, further comprising updating the temperature envelopes of the components during the operational phase.

15. A system comprising:
a server comprising:
a baseboard management controller (“BMC”) connected to a remote management server over a management network;
a temperature sensor array (“TSA”) comprising a grid of infrared (“IR”) sensors located within the TSA, the TSA coupled to a structure facing electronic components of the server;
integrated electronics connected to the TSA, the integrated electronics configured to provide a thermal image of an area below the TSA;
a motherboard of the server comprising a processor, the motherboard coupled to the integrated electronics;
non-transitory computer readable storage media storing code, the code being executable by the processor to perform operations comprising:
reading the thermal image;
determining temperatures of the components of the server; and
reporting the temperatures of the components of the server.

16. The system of claim 15, wherein the TSA is a first TSA comprising first IR sensors that are spaced apart from each other at a first spacing and further comprising a second TSA comprising second IR sensors that are spaced apart from each other at a second spacing, the first spacing different than the second spacing, wherein the integrated electronics is a first integrated electronics and the second TSA connected to one of the first integrated electronics and a second integrated electronics, the first or second integrated electronics coupled to the second TSA configured to provide a thermal image of an area below the second TSA, the first or second integrated electronics connected to the second TSA connected to the motherboard.

17. The system of claim 15, wherein the non-transitory computer readable storage media stores further code executable by the processor to perform further operations comprising corelating components of the server with locations on the thermal image, wherein reading the thermal image and determining temperatures of the electronic components of the server comprises reading a temperature on the thermal image corelated with each component of the server.

18. The system of claim 15, wherein the non-transitory computer readable storage media stores further code executable by the processor to perform further operations comprising:
mapping components under the TSA with locations on a thermal image of the TSA;
reading, using the TSA, thermal images during various conditions comprising startup conditions, transient conditions, and/or various operating conditions;
correlating temperatures of the components of the thermal images with the various conditions to establish baseline temperatures of the components at the various conditions; and
creating a temperature envelope for one or more components of the server based on the temperature correlations.

19. The system of claim 18, wherein correlating the temperatures with the various conditions uses machine learning during a training phase and wherein reading the thermal image comprises reading thermal images during various conditions, and further comprising:
comparing, during an operational phase, temperatures of a component from the thermal images with the temperature envelope for the component;
sending an alert in response to a temperature of the component exceeding the temperature envelope by a specified amount; and
updating the temperature envelopes of the components during the operational phase.

20. An apparatus comprising:
a temperature sensor array (“TSA”) comprising a grid of infrared (“IR”) sensors located within the TSA, the TSA coupled to a structure facing electronic components of a server;
integrated electronics connected to the TSA, the integrated electronics configured to provide a thermal image of an area below the TSA;
a motherboard of the server comprising a processor, the motherboard coupled to the integrated electronics;
non-transitory computer readable storage media storing code, the code being executable by the processor to perform operations comprising:
mapping components under the TSA with locations on a thermal image of the TSA;
reading, using the TSA and during a training phase, thermal images during various conditions comprising startup conditions, transient conditions, and/or various operating conditions;
correlating, using machine learning during the training phase, temperatures of the components of the thermal images with the various conditions to establish baseline temperatures of the components at the various conditions;
creating, during the training phase and using machine learning, a temperature envelope for one or more components of the server based on the temperature correlations;
reading, during an operational phase, a thermal image during a particular condition;
comparing, during the operational phase, a temperature of a component from the thermal image with a temperature envelope for the component corresponding to the particular condition;
sending an alert in response to a temperature of the component exceeding the temperature envelope by a specified amount; and
updating the temperature envelopes of the components during the operational phase.
